(19) United States
(12) Patent Application Publication
(10) Pub. No.: US 2018/0272331 A1
(43) Pub. Date: Sep. 27, 2018

(54) DEVICE FOR PREPARING AND DISPENSING BIOLOGICAL SAMPLE

(71) Applicant: BODITECH MED INC., Chuncheon-si, Gangwon-do (KR)

(72) Inventors: Eui Yul CHOI, Chuncheon-si (KR); Hoo Don JOO, Chuncheon-si (KR); Byeong Chul KIM, Chuncheon-si (KR); Kyong-Hwa CHONG, Goyang-si (KR); Jae Min LEE, Chuncheon-si (KR); Min Seok CHA, Chuncheon-si (KR); Sung Mi JU, Chuncheon-si (KR); Hye Jin LEE, Chuncheon-si (KR); Myung Hee SON, Namyangju-si (KR); Do Won KIM, Chuncheon-si (KR); Sang Hyun PARK, Seoul (KR)

(73) Assignee: BODITECH MED INC., Chuncheon-si, Gangwon-do (KR)

(21) Appl. No.: 15/562,358

(22) PCT Filed: Mar. 25, 2016
(86) PCT No.: PCT/KR2016/003032

§ 371 Date: Sep. 27, 2017

(30) Foreign Application Priority Data
Mar. 27, 2015 (KR) 10-2015-0043193
Mar. 24, 2016 (KR) 10-2016-0035205

(51) Int. Cl. B01L 3/02

(52) U.S. Cl. CPC B01L 3/021; B01L 2200/06; B01L 2300/042; B01L 2300/0832; B01L 2200/14

(57) ABSTRACT

The present disclosure provides a device for preparing and dispensing biological sample. Sampling, mixing of the sample with a specific solution, and loading of the mixture, can be achieved in an accurate and convenient manner.

### TECHNICAL FIELD

The present disclosure relates to a device for sampling, sample preparation or sample dispensing, and more particularly to a device that may be used in an in vitro diagnostic system.

### BACKGROUND ART

Generally, various chemical or biochemical testing methods for measuring biological markers associated with specific diseases, general health conditions, or infections, are performed by multi-step chemical reactions and physical operations using various reagents and devices. For example, for detection of a certain chemical substance or a biochemical substance such as protein in a sample such as blood, several physical operation steps are required, including sampling, reacting the sample with one or more reagents in a certain vessel, and dispensing the reacted sample from the vessel.

For example, in order to perform lateral flow immunoassay in the case in which a sample (for example, blood), a detection antibody labeled with a fluorescent substance or the like, and whole blood, are used, a predetermined amount of a solution (reagent) containing an erythrocyte-lysing reagent is generally added thereto and reacted. Then, the sample is loaded onto the sample pad of a lateral flow assay device or cartridge comprising the sample pad and a membrane having immobilized thereon an antibody specific for the substance to be detected in the blood. In this case, the sample should be loaded in an accurate amount (usually 50 to 150 μL) in order to make accurate and reproducible analysis possible.

Thus, dispensing an accurate volume in each of the above-described steps is important in obtaining reproducible results. In this process, a pipette is generally used to dispense the sample. However, in this case, there are disadvantages in that it is not possible to always collect or load an accurate amount in every step, due to a difference between devices, a difference between users, or temporal and spatial differences between the same users, and in that the operating method is inconvenient and preparation of the sample is time-consuming. Thus, in order to ensure the accuracy of results, a device and method capable of performing sampling and loading in a consistent and accurate manner are required.

### PRIOR ART DOCUMENTS

### Patent Documents

Korean Patent Application Publication No. 2003-0078615.

### DISCLOSURE

### Technical Problem

The present disclosure has been made in order to solve the above-described problems, and it is an object of the present disclosure to provide a device and a method, which are capable of reproducibly and accurately performing sampling, a chemical or biological detection reaction, and detection and analysis including the loading and separation of a reaction product.

### Technical Solution

A sample dispensing device according to one embodiment of the present disclosure comprises: a chamber having formed therein a first hollow extending in a longitudinal direction, the first hollow having an opening at one end; a housing which has a second hollow and whose one end is connected to the chamber, in which the second hollow is open at both ends and communicates with the first hollow of the chamber; and a buffer tube which has an opening at one end and whose end having the opening is connected and fixed to the other end of the housing, the buffer tube having a filling space configured to be filled with a solution, wherein the chamber has a sampling portion provided at the other end of the first hollow and configured to collect a sample or to discharge a fluid from the first hollow, and also has an extending protrusion provided in the first hollow and extending in the lengthwise direction of the first hollow, and wherein the buffer tube has a sealing membrane configured to seal the opening so as to retain the solution in the filling space, and wherein the housing is connected to the chamber so that it is movable with respect to the chamber, and the housing is configured such that when the housing moves downward with respect to the chamber, the sealing membrane is perforated by the extending protrusion so that the solution will be discharged to an outside through the sampling portion.

In one embodiment, the housing is connected to the chamber in such a manner that one end thereof is inserted into the first hollow of the chamber so that the housing is movable with respect to the chamber.

In another embodiment, the outer diameter of one end of the housing corresponds to the inner diameter of the first hollow of the chamber so that the housing is tightly fitted into the first hollow of the chamber.

In still another embodiment, the other end of the housing has a stopper protrusion which extends outward so as to have a predetermined width and which enables the housing to be fixed in position when the housing is inserted into the first hollow.

In still another embodiment, the sample dispensing device further comprises a fixing ring inserted in the second hollow of the housing, wherein the housing comprises an inner protrusion which is provided at a position corresponding to the other end and which protrudes inward in the diameter direction of the second hollow so as to have a certain width, and the buffer tube comprises, at one side having the opening, an outer protrusion that protrudes outward, and the fixing ring is tightly fitted into the second hollow of the housing so that the outer protrusion is located and supported between the inner protrusion and the fixing ring, whereby the buffer tube is fixed to the housing.

In still another embodiment, the inner protrusion has a plurality of vent holes which extend in a direction in which the second hollow extends, in which the vent holes are arranged in a circumferential direction so as to be spaced apart from each other, and the fixing ring is configured such that at least a portion thereof is smaller than the inner diameter of the second hollow so as to be spaced at a predetermined distance from the inner circumferential surface of the second hollow so as to form a gap, so that air in the housing may be discharged to an outside through the vent holes and the gap.

In still another embodiment, the chamber have a bottom provided at the other end at which the sampling portion is located, and the sampling portion is configured to protrude from the bottom in such a manner that the bottom is inclined from the peripheral portion thereof toward the central portion so as to protrude outward, and that the sampling portion is located in the center of the bottom.

In still another embodiment, the extending protrusion consists of a plurality of extending protrusions spaced at a predetermined distance from each other, in which each of extruding protrusions protrudes and extends from the bottom portion, and a region between the extruding protrusions comes in contact with the bottom.

In still another embodiment, the extending protrusion further extends outward so as to pass through the opening of the first hollow.

In another aspect, the present disclosure is directed to a method for analyzing a biological sample using the device of the present disclosure, the method comprising: providing a biological sample; bringing the sampling portion of the device into contact with the biological sample to flow in the biological sample into the sampling portion; and operating the device to perforate the sealing membrane by the extending protrusion and thereby to move the solution into the space of the housing during which the chamber and mix the solution with the biological sample and the mixture of the solution and the biological sample is discharged to an outside through the sampling portion.

A sample dispensing device according to another embodiment of the present disclosure comprises: a chamber portion having a vertically extending dual-tube structure; an upper cap having a vertically extending dual-tube structure and disposed above the chamber portion, the upper cap being configured to be filled with a predetermined solution; and a sampling portion disposed at the bottom of the chamber portion and having a tubular channel through which a specific sample is collected or the solution is discharged, wherein the chamber portion comprises: a cylindrical outer circumferential portion which constitutes an outer circumference and which has a first hollow open at its upper end and having a predetermined inner diameter; a cylindrical line portion disposed in the first hollow so as to be spaced at a predetermined distance from the outer circumferential portion in the diameter direction, the cylindrical line portion extending in the lengthwise direction of outer circumferential portion and having a vertically extending discharge line; an inner groove defined by a space between the outer circumferential portion and the line portion; and a lower-end connecting portion which connects the lower end of the outer circumferential portion with the lower end of the line portion; the upper cap comprises: a cap portion which constitutes the outer circumference and has a second hollow at open at its lower end and having a predetermined inner diameter; a tube portion disposed in the second hollow so as to be spaced at a predetermined distance from the cap portion in the diameter direction, the tube portion extending in the lengthwise direction of the cap portion and having a solution filling space open at its lower end; an outer groove defined by a space between the cap portion and the tube portion; a cap cover which connects the upper end of the cap portion with the upper end of the tube portion and closes the upper end of the tube portion; and a sealing cover provided at the lower end of the tube portion so as to seal the lower end of the solution filling space and made of a thin membrane, wherein the upper cap is connected to the chamber portion so as to be vertically movable with respect to the chamber portion, in such a manner that the line portion is located below the tube portion, and the upper cap is configured such that when the upper cap moves downward, the sealing cover is perforated by the line portion and the solution passes through the discharge line and is discharged to an outside through the tubular channel of the sampling portion.

In one embodiment, the lower end of the upper cap is connected to the upper end of the chamber portion in such a manner that the outer circumferential portion of the chamber portion is inserted into the outer groove of the upper cap and inserted between the cap portion and the tube portion, and the cap portion is configured such that when the upper cap moves downward by an external force, the outer circumferential portion is inserted into the outer groove and the line portion is inserted into the solution filling space of the tube portion.

Preferably, the outer surface of the upper end of the outer circumferential portion has a first locking protrusion portion which protrudes outward in the diameter direction so as to have a predetermined width, and the inner surface of the lower end of the cap portion has a second locking protrusion portion which protrudes inward in the diameter direction so as to have a predetermined width, and thus when the lower end of the upper cap portion is coupled to the upper end of the chamber portion, the first locking protrusion portion and the second locking protrusion portion are interlocked with each other so that the upper end of the outer circumferential portion is tightly fitted between the cap portion and the tube portion, whereby the lower end of the cap portion and the upper end of the chamber portion are connected to each other and fixed in position.

In another embodiment, the first locking protrusion portion is composed of a circular protrusion portion extending along the upper outer circumference of the outer circumferential portion; the second locking protrusion portion comprises: a plurality of upper protrusions which protrude inward in the diameter direction of the cap portion so as to have a predetermined width, extend in a circumferential direction so as to have a predetermined length, and are spaced apart at a predetermined distance from each other; and a plurality of lower protrusions which are disposed below the upper protrusions so as to be spaced at a predetermined distance in the vertical direction, protrude inward in the diameter direction of the cap portion so as to have a predetermined width, extend in a circumferential direction so as to have a predetermined length, and are spaced apart at a predetermined distance from each other; and when the lower end of the upper cap portion is coupled to the upper end of the chamber portion, the upper protrusions are located over the first locking protrusion portion, and the lower protrusions are located beneath the first locking protrusion portion, whereby the cap portion and the chamber portion are fixed in position.

In still another embodiment, the upper protrusions and the lower protrusions are alternately disposed in the circumferential direction of the inner circumferential surface of the cap portion.

In still another embodiment, the outer circumference of the lower end of the tube portion has a frictional protrusion which protrudes outward so as to have a predetermined width and which extends in the circumferential direction to come into close contact with the inner circumferential surface of the upper end of the outer circumferential portion.

In still another embodiment, the height of the line portion is smaller than the height of the outer circumferential portion, and thus when the upper end of the outer circumferential portion is tightly connected with the lower end of the cap portion, the sealing cover and the line portion are spaced apart from each other in a vertically direction, and when the upper cap moves downward by a predetermined distance, the line portion perforates the sealing cover so that the solution in the solution filling space is discharged through the discharge line.

In still another embodiment, the outer diameter and cross-sectional shape of the line portion correspond to the inner diameter and cross-sectional shape of the solution filling space, and thus when the upper cap moves downward, the line portion perforates the sealing cover and is inserted into the solution filling space, and the solution in the solution filling space is discharged through the discharge line without being discharged to an outside.

In still another embodiment, the upper end of the discharge line has an enlarged portion which has a funnel shape whose inner diameter increases upward.

In still another embodiment, the upper end of the line portion has a ripping portion configured to rip the sealing cover, in which the ripping portion comprises: at least one transverse beam provided at the upper end of the discharge line so as to traverse the discharge line in the diameter direction; and an upwardly protruding blade portion disposed at the upper end of the transverse beam.

In still another embodiment, the chamber portion further comprises a recess formed by the lower portion of the line portion, which is recessed upward, in which the recess has a first hemispherical dome, which is located at an upper portion and has a hemispherical shape and is recessed upward, and an inwardly recessed region which is located beneath the first hemispherical dome and has a cylindrical shape having an inner diameter greater than the diameter of the first hemispherical dome, and the sampling portion has an inner fitting portion which is located in an upper portion of the sampling portion and has a cylindrical shape and an outer diameter corresponding to the inner diameter of the inwardly recessed region so as to be inserted into the inwardly recessed region, a sampling tip which is located in a lower portion of the sampling portion and has a slender tube shape so as to collect a sample, and a second hemispherical dome which is formed on the inner fitting portion and has a hemispherical shape and is recessed downward so as to form a spherical space together with the first hemispherical dome.

In still another embodiment, a female screw portion is formed on the inner circumferential surface of the inwardly recessed region, and a male screw portion that is coupled with the female screw portion is formed on the outer circumferential surface of the inner fitting portion.

In still another embodiment, the sample dispensing device according to the embodiment of the present disclosure further comprises a dry reagent obtained by drying a predetermined reagent, in which the dry reagent is disposed in the spherical space formed by the first hemispherical dome together with the second hemispherical dome and is dissolved and mixed with the solution when the solution is discharged.

The sample dispensing device according to the embodiment of the present disclosure may further comprise a sample adapter, in which the sample adapter comprises: a chamber insertion holder having a space therein and configured such that the lower end of the chamber portion is tightly inserted therein; a slope provided at a bottom in the chamber insertion holder and inclined in one direction and configured to guide the discharged sample and solution in one direction; and a cartridge insertion portion configured such that a cartridge for use in analysis of the sample is inserted therein.

### Advantageous Effects

According to the present disclosure, sampling, mixing of the sample with a specific solution, and loading of the mixture, can be achieved in an accurate and convenient manner. For example, when a lateral flow immunoassay is used, accurate sampling, mixing of the sample with a specific solution, and accurate loading of the mixture into a lateral flow immunoassay device, are required, and a specific tool such as a pipette is required to perform the lateral flow immunoassay, and in this case, a non-skilled user cannot perform the lateral flow immunoassay in an accurate manner. However, when the device according to the present disclosure is used, a sample can be simply collected by the sampling portion provided in the device, and it can be mixed and reacted with a predetermined amount of a specific solution. A predetermined amount of the reacted solution can be accurately loaded through the sampling portion into a cartridge provided in a lateral flow immunoassay device or the like. Thus, overall analysis can be very simply achieved without a complicated operation.

### DESCRIPTION OF DRAWINGS

FIGS. 1A to 1C illustrate the structure of a sampling and sample dispensing device according to one embodiment of the present disclosure.

FIG. 2 is an exploded view showing the structure of a sample dispensing device according to one embodiment of the present disclosure.

FIG. 3 shows a state in which a housing in a sample dispensing device according to one embodiment of the present disclosure is inserted into the chamber of the device.

FIG. 4 is an exploded view showing the coupling structure between a housing, a buffer tube and a fixing ring in a sample dispensing device according to one embodiment of the present disclosure.

FIG. 5 shows an air discharge region formed by the coupling structure between a housing and a fixing ring in a sample dispensing device according to one embodiment of the present disclosure.

FIG. 6 shows the sequential steps of an analysis process that is performed using a sample dispensing device according to an embodiment of the present disclosure.

FIG. 7 shows the appearance of a sample dispensing device according to another embodiment of the present disclosure.

FIG. 8 is an exploded view of the sample dispensing device shown in FIG. 7.

FIG. 9 is an exploded cross-sectional view of the sample dispensing device shown in FIG. 7.

FIG. 10 is a cross-sectional view of the sample dispensing device shown in FIG. 7.

FIG. 11 is a cross-sectional view of the sample dispensing device shown in FIG. 7, which contains a dry reagent.

FIG. 12 is a cross-sectional view of the sample dispensing device shown in FIG. 7.

FIG. 13 shows an adapter and the sample dispensing device of FIG. 7 and cartridge inserted therein.

FIG. 14 shows the internal structures of an adapter and a cartridge inserted therein.

FIGS. 15A and 15B are a cross-sectional view of an adaptor and a cross-sectional view obtained by sectioning FIG. 14 in the lengthwise direction, respectively.

### MODE FOR INVENTION

The advantages and features of the present invention, and the way of attaining them, will become apparent with reference to the exemplary embodiments described below in conjunction with the accompanying drawings. However, the present disclosure is not limited to the exemplary embodiments disclosed below and can be embodied in a variety of different forms; rather, these embodiments are provided so that this disclosure will be thorough and complete, and will fully convey the scope of the present disclosure to those skilled in the art. The scope of the present disclosure will be defined by the appended claims. Like reference numerals refer to like elements throughout the specification.

Spatially relative terms, such as “below”, “lower,” “above”, “upper”, “side” and the like, may be used herein for ease of description to describe the relationship of one element to another element(s) as illustrated in the figures. It will be understood that the spatially relative terms are intended to encompass different orientations of an element in use or operation, in addition to the orientation depicted in the figures. For example, if the device in the figures is turned over, elements described as “above” relative to other elements would then be oriented “below” the other elements. Thus, the exemplary term “above” can encompass both an orientation of above and below. The device may be otherwise oriented and the spatially relative descriptors used herein interpreted accordingly.

The terminology used herein is for the purpose of describing particular embodiments only and is not intended to limit the scope of the present disclosure. As used herein, the singular forms are intended to include the plural forms as well, unless the context clearly indicates otherwise. It will be further understood that the terms “comprises” and/or “comprising,” when used in this specification, specify the presence of stated elements, steps, operations and/or components, but do not preclude the presence or addition of one or more other elements, steps, operations and/or components.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, will not be interpreted in an idealized or overly formal sense unless expressly so defined herein.

In the drawings, the thickness or size of each element is exaggerated, omitted, or schematically illustrated for convenience in description and clarity. Furthermore, the size of each element does not entirely reflect an actual size.

Furthermore, directions used to describe the configuration of the present disclosure in embodiments are based on those shown in the drawings. Unless a reference point or positional relation with respect to a direction is not clearly defined in the specification, reference will be made to the relevant drawings.

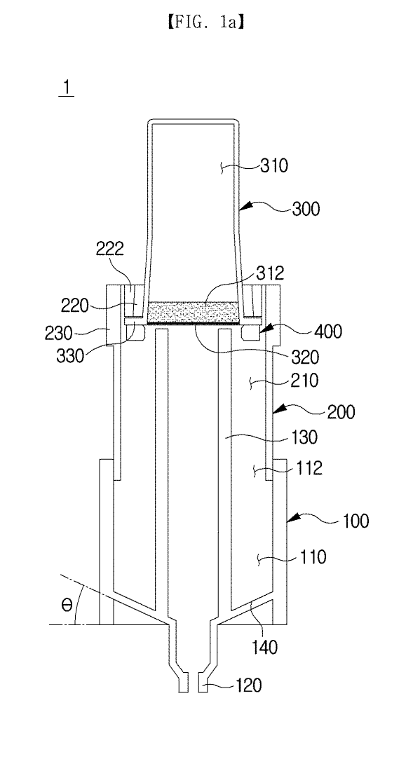

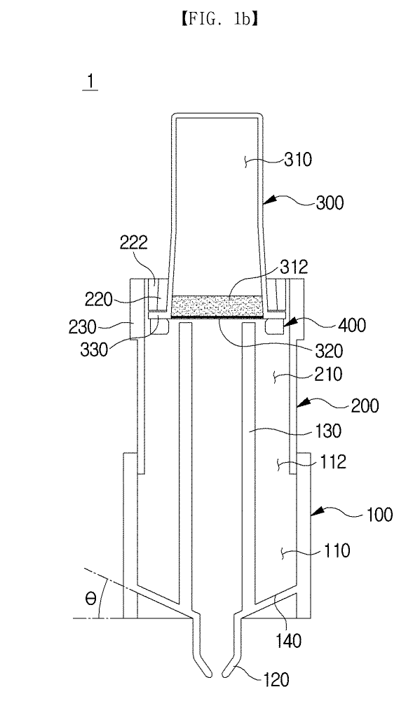

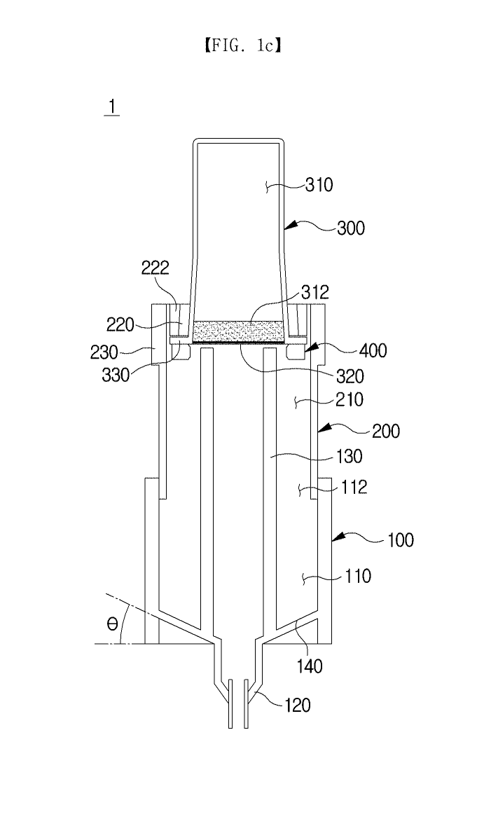

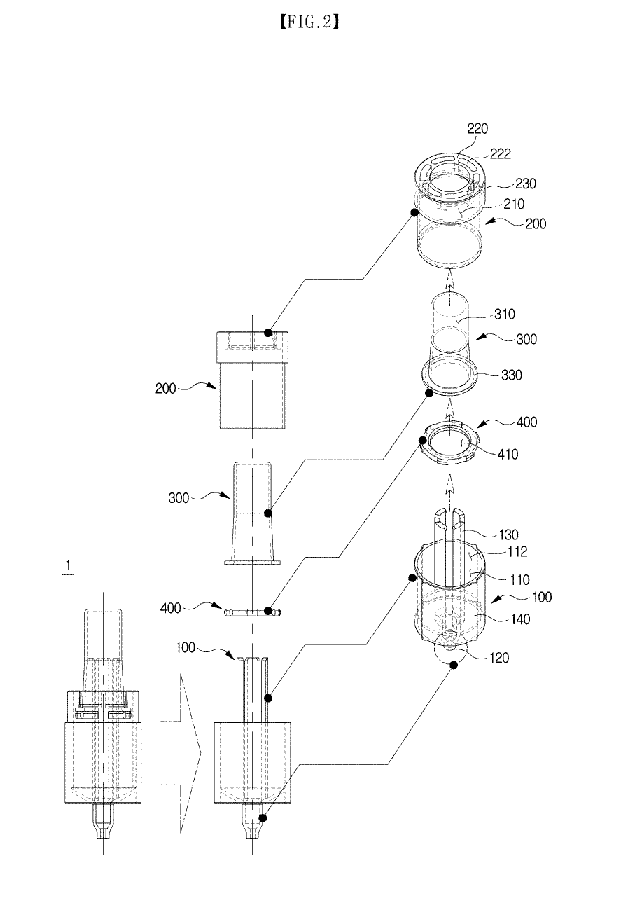

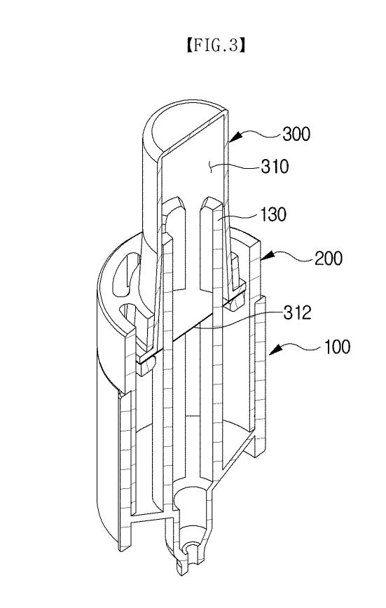

FIGS. 1A to 1C illustrate the structure of a sampling and sample dispensing device 1 according to one embodiment of the present disclosure; FIG. 2 is an exploded view showing the structure of a sample dispensing device 1 according to one embodiment of the present disclosure; and FIG. 3 shows a state in which a housing 200 in a sample dispensing device 1 according to one embodiment of the present disclosure is inserted into a chamber 100.

A sample dispensing device 1 according to one embodiment of the present disclosure comprises: a chamber 100 having formed therein a first hollow 110 extending in a longitudinal direction, the first hollow 110 having an opening 112 at one end; a housing 200 which has a second hollow 210 and whose one end is connected to the chamber 100, in which the second hollow 210 is open at both ends and communicates with the first hollow 110 of the chamber 100; and a buffer tube 300 which has an opening at one end and whose end having the opening is connected and fixed to the other end of the housing 200, the buffer tube 300 having a filling space 310 configured to be filled with a solution 312; wherein the chamber 100 has a sampling portion 120 provided at the other end of the first hollow 110 and configured to collect a sample or to discharge a fluid from the first hollow 110, and an extending protrusion 130 provided in the first hollow 110 and extending in the lengthwise direction of the first hollow 110, and wherein the buffer tube 300 has a sealing membrane 320 configured to seal the opening so as to retain the solution 312 in the filling space 310, and wherein the housing 200 is connected to the chamber 100 so as to be movable with respect to the chamber 100, and the housing 200 is configured such that when the housing 200 moves downward with respect to the chamber 100, the sealing membrane 320 is perforated by the extending protrusion 130 so that the solution 312 will be discharged to an outside through the sampling portion 120.

The chamber 100 may, for example, have a cylindrical shape or a polygonal tubular shape. Preferably, the chamber may have a cylindrical shape as shown in the drawings, but is not limited thereto.

In the chamber 100, a first hollow 110 is provided which extends in a longitudinal direction and has an opening 112 at one end. As used herein, the term “longitudinal direction” means a direction in which the first hollow 110 is famed as shown in the drawings. At one end of the chamber 100, the opening 112 is provided so that the first hollow 110 is open to expose the internal space.

At the other end of the chamber 100, a sampling portion 120 is provided. As used herein, the term “other end” refers to a position opposite to the one end having the opening 112, and both ends in the longitudinal direction in which the hollow extends are defined as one end and the other end, respectively. The sampling portion 120 is an element through which a sample such as blood is introduced into the device 1 of the present disclosure by surface tension or the like. The sampling portion 120 may have a tubular shape, and the shape thereof is not limited. For example, as shown in FIG. 1A, the sampling portion 120 may be composed of a slender tube having a small inner diameter, or as shown in FIG. 1B, may be composed of a ring-shaped element having a certain inner diameter. Meanwhile, as shown in FIG. 1C, the sampling portion 120 may also be composed of a slender tube which is inserted into the cylindrical tube. Meanwhile, the slender tube may be configured such that it protrudes outward and protrudes inward toward the chamber 100 by a certain length so that a predetermined amount of the sample will be introduced into the chamber. Meanwhile, the specific configuration of the sampling portion is not limited, and the sampling portion 120 may any shape and length. The sampling portion 120 communicates with the first hollow 110. Accordingly, a certain liquid sample may be collected or discharged through the sampling portion 120 by, for example, a capillary phenomenon resulting from surface tension. In addition, since the sampling portion 120 communicates with the first hollow 110, a fluid in the first hollow 110 may be discharged to an outside through the sampling portion 120. Due to this configuration, it appears that the chamber 100 is essentially open at both ends. However, for easy description, it will be described that an opening 112 is provided on one end of the chamber 100 and the sample or sampling portion 120 is provided at the other end.

Specifically speaking, the chamber 100 may have a bottom 140 provided at the other end at which the sampling portion 120 is located. The sampling portion 120 may be configured to protrude from the bottom 140. As used herein, the tam. “bottom 140” refers to a portion that partially closes the other end, and the direction thereof is not necessarily limited to the bottom. The bottom 140 is provided in such a manner that the sampling portion 120 protrudes from the bottom 140. Thus, the chamber 100 may be configured to have the opening 112 at one end and the sampling portion 120 at the other end.

Preferably, the bottom 140 may be configured to be inclined from the peripheral portion toward the central portion and to protrude outward, and may also be configured such that the sampling portion 120 is located in the center of the bottom 140. Namely, as shown in the drawings, the bottom 140 is composed of a slope having an inclination angle 19, the center thereof protrudes outward, and the sampling portion 120 is disposed in the center of the bottom 140. Thus, the bottom may have an approximately funnel shape. Accordingly, a fluid in the first hollow 110 of the chamber 100 may be easily discharged to an outside through the sampling portion 120.

In the first hollow 110 of the chamber 100, an extruding protrusion 130 is provided. The extending protrusion 130 is provided in the first hollow 110, but the entire portion thereof does not need to be located in the first hollow 110. Namely, as shown in the drawings, the extending protrusion 130 may be configured to extend upward in the first hollow 110 and protrude outward through the opening 112 by a certain length.

Preferably, the extending protrusion 130 may consists of a plurality of extending protrusions 130 spaced at a predetermined distance from each other, in which each of the plurality of extruding protrusions 130 protrudes and extends from the bottom 140, and a region between the extruding protrusions 130 comes in contact with the bottom 140.

Namely, the extending protrusion 130 is configured to extend and protrude from the inner side of the bottom 140 (which is the other end of the chamber 100) toward the opening 112 and is provided in a plural number, in which the plurality of extending protrusions 130 may be spaced at a predetermined distance from each other. Herein, the region between the extending protrusions 130 comes in contact with the bottom 140 and extends to the sampling portion 120, so that a fluid in the chamber 100 can be easily discharged into the sampling portion 120 without interference.

The housing 200 has a second hollow 210 which is open at both ends and which communicates with the first hollow 110 of the chamber 100, and the housing 200 is configured such that one end thereof is connected to the chamber 100. Specifically, the housing 200 has a second hollow 210 open at both ends and is connected to the chamber 100. More specifically, the housing 200 is configured such that one end of the housing 200 is connected to the opening 112 of the chamber 100 so as to allow the second hollow 210 to communicate with the first hollow 110. As used herein, the term “communicate” means that the space of the first hollow 110 and the space of the second hollow 210 are connected with each other so that a fluid or the like may move between the first hollow and the second hollow.

The housing 200 is connected to the chamber 100 so that it will move with respect to the chamber 100. Namely, the housing 200 may displace relative to the chamber 100 so that it may move from the position, at which it is connected to the chamber 100, downward into the chamber 100. Since displacement of the housing 200 is relative displacement, it can be said in another aspect that the chamber 100 is connected so that the position thereof may change with respect to the housing 200. In addition, the expression “move downward . . . into” does not necessarily mean that one of the two elements moves from a position, at which the two elements are spaced apart from each other, to a position at which the two elements are near each other, but may be understood to mean that one of two elements displaces from a position at which the two elements overlap each other, so that the size of the overlapped portion will further increase.

Preferably, the housing 200 may be configured such that one end thereof is inserted in the first hollow 110 of the chamber 100 and is movably connected to the chamber 100. Namely, as shown in FIG. 1, one end of the housing 200 is inserted in the first hollow 110 of the chamber 100 through the opening 112, so that the housing 200 may be movably connected to the chamber 100 and the second hollow 210 of the housing 200 may communicate with the first hollow 110 of the chamber 100. In addition, the housing 200 may be configured such that when the depth of insertion of the housing 200 changes, the housing 200 displaces with respect to the chamber 100. Namely, one end of the housing 200 is inserted in the chamber 100 and the housing 200 is connected to the chamber 100. In this case, when the housing 200 is pushed down so as to be further inserted into the chamber 200, positional displacement between the chamber 100 and the housing 200 may be achieved.

Preferably, the outer diameter of one end of the housing 200 corresponds to the inner diameter of the first hollow 110 of the chamber 100, so that the housing 200 can be fitted into the first hollow 110 of the chamber 100. Namely, when the outer diameter of the housing 200 corresponds to the inner diameter of the first hollow 110 of the chamber 100 and the housing 200 is inserted into the opening 112 of the chamber, the housing 200 can be fitted into the chamber 100. Accordingly, the housing 200 and the chamber 100 may have a structure such as a cylinder or a piston. As used herein, the term “corresponds to” may be understood to mean that the two elements have very similar size. Herein, the sizes may be perfectly the same, or may very slightly differ from each other. It is to be understood that the shapes of the two elements should correspond to each other.

Preferably, at the other end of the housing 200, a stopper protrusion 230 is provided which extends outward so as to have a certain width and which enables the housing 200 to be fixed in position when the housing 200 is inserted into the first hollow 110. Namely, in order to prevent the housing 200 from being completely inserted and buried in the chamber 100, a stopper protrusion 230, which extends outward so as to have a certain width, is provided at the other end of the housing 200. When the housing 200 is inserted deeply into the first hollow 110, it will come into contact with the stopper protrusion 230 and will be no longer inserted and will be fixed in position, thereby preventing the housing 200 from being excessively inserted and buried.

The buffer tube 300 is an element configured to be filled with a solution 312. The buffer tube 300 has a filling space 310 configured to receive the solution 312. At one end of the filling space 310, an opening is provided so that the filling space is open. The end having the opening is connected and fixed to the other end of the housing 200. As used herein, the expression “other end of the housing 200” means the end opposite to one end of the housing 200 which is connected to the chamber 100.

The buffer tube 300 has a sealing membrane 320 configured to seal the opening so as to maintain the solution 312 contained in the filling space 310. The sealing membrane 320 is configured to close the filling space 310 so as to prevent the solution 312 in the filling space 310 from unnecessarily flowing out. Preferably, after a solution 312 is filled in the filling space 310, the sealing membrane 320 is disposed at the opening by a process such as attachment, bonding or the like, so that the solution 312 in the filling space 310 may be maintained in a filled state. Meanwhile, the sealing membrane 320 has a relatively thin membrane structure so that it can be suitably broken by the extending protrusion 130 as described below. For example, the sealing membrane 320 may be made of a thin aluminum film, a thin vinyl film or the like, but is not limited thereto.

In addition, since an air discharge region composed of the vent holes and the gap of the fixing ring is provided, air in the housing, the buffer tube and the chamber can be easily discharged, and the sample and the solution can easily flow down.

Hereinafter, the operation of the sampling and sample dispensing device 1 according to the present disclosure will be described.

Referring to the drawings, the buffer tube 300 is connected to the upper end of the housing 200, and the chamber 100 is connected to the lower end of the housing 200. The extending protrusion 130 in the chamber 100 extends upward so that it can come into close contact or come into contract with the sealing membrane 320 provided at the lower end of the buffer tube 300. As described above, the housing 200 is fixedly connected to the buffer tube 300, and the housing 200 is movably connected to the chamber 100. As the housing 200 moves downward into the chamber 100, the buffer tube 300 also moves downward toward the housing 200, and as shown in FIG. 3, the extending protrusion 130 perforates the sealing membrane 320 provided at the lower end of the buffer tube 300. Thus, the solution 312 in the buffer tube 300 can flow down and can be discharged through the sampling portion 120.

A specific liquid sample, for example, such as blood, plasma or serum, may be introduced into the sampling portion 120 by surface tension, and then the housing 200 may be operated to break the sealing membrane of the buffer tube, so that the solution 312 may be suitably mixed with the sample. Meanwhile, because a predetermined amount of the solution 312 may be filled into the buffer tube 300 by a specific feeding device, a predetermined amount of the solution 312 may be conveniently mixed with the sample.

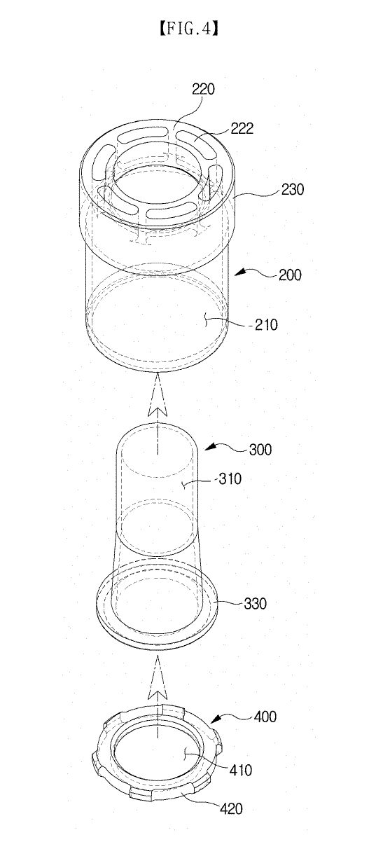

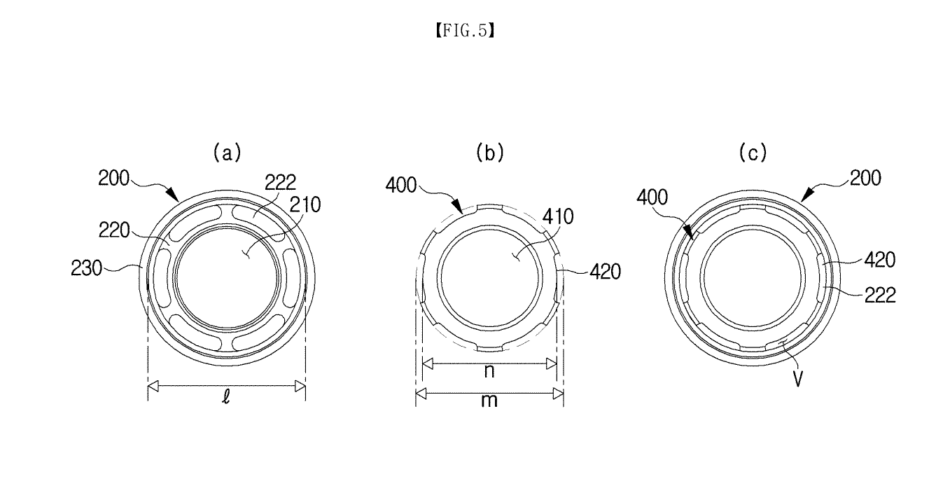

FIG. 4 is an exploded view showing the coupling structure between a housing 200, a buffer tube 300 and a fixing ring 400 in a sample dispensing device 1 according to one embodiment of the present disclosure, and FIG. 5 shows an air discharge region V formed by the coupling structure between a housing 200 and a fixing ring 400 in a sample dispensing device 1 according to one embodiment of the present disclosure.

According to a preferred embodiment, the buffer tube 300 and the housing 200 may have a more specific coupling structure.

Preferably, the housing 200 may further comprise a fixing ring 400 which is fitted into the second hollow 210, and the housing 200 may comprise an inner protrusion 220 which is provided at a position corresponding to the other end and which protrudes inward in the diameter direction of the second hollow 210 so as to have a certain width. The buffer tube 300 may comprise, at one side having the opening, an outer protrusion 330 that protrudes outward. The fixing ring 400 may be tightly fitted into the second hollow 210 of the housing 200 so that the outer protrusion 330 may be located and supported between the inner protrusion 220 and the fixing ring 400, whereby the buffer tube 300 may be fixed to the housing 200.

The fixing ring 400 is a ring-shaped element having a through-opening 410 therein. As used herein, the term “ring-shaped” refers to any shape having a through-opening 410 therein, and is not necessarily limited to a circular ring. The fixing ring 400 may have any shape that may be tightly fitted into the second hollow 210 of the housing 200.

The housing 200 has an inner protrusion 220 which is provided at the other end and which protrudes inward in the diameter direction of the second hollow 210 so as to have a certain width. Namely, at the other end of the housing 200, the inner protrusion 220 may be provided which protrudes inward from the inner circumferential surface so as to have a certain width. In other words, the second hollow 210 at the other end of the housing 200 may have an inner diameter smaller than those of other elements to provide a stepped structure. As used herein, the term “other end” means a position opposite to the position at which the housing is connected to the chamber 100 as described above. Meanwhile, the inner protrusion 220 may have a specific ring shape, but is not limited thereto. In addition, the inner protrusion 220 may also be composed of structures, such as one or more protrusions, which protrude inward and are spaced apart from each other.

The buffer tube 300 has, at one side having the opening, an outer protrusion 330 that protrudes outward. The outer protrusion 330 is provided in the outer circumferential portion of the end having the opening, and is configured to protrude outward from the outer circumferential portion. The outer protrusion 330 may generally have a shape such as a ring, but is not limited thereto. Specifically, the outer protrusion 330 may also be composed of structures, such as a plurality of protrusions, which protrude outward so as to be spaced apart from each other.

The outer protrusion 330 of the buffer tube 300 and the inner protrusion 220 of the housing 200 come into contact with each other and are fixed in position. Namely, as shown in the drawings, the buffer tube 300 is inserted into the second hollow 210 of the housing 200 and passes through the other end of the housing 200, so that the outer protrusion 330 and the inner protrusion 220 may come in contact with each other and be fixed in position. Accordingly, the outer protrusion 330 and the inner protrusion 220 come in contact with each other and are supported by each other, and may have a suitable structure that can achieve the support. Namely, the outer protrusion 330 and the inner protrusion 220 may preferably have a ring shape so that they may come in contact with each other, but they may also be composed of structures such as protrusions.

In addition, the inner diameter of the second hollow 210, defined by the inner protrusion 220, and the outer diameter of the buffer tube 300, defined by the outer protrusion 330, and the outer diameter of the buffer tube 300, may have sizes suitable to provide the coupling structure as shown in the drawings. Namely, the outer diameter of other portion of the buffer tube 300, excluding the outer protrusion 330, is smaller than the inner diameter of the portion having the inner protrusion 220 formed therein, so that the other portion is suitable for passing through the other end of the housing 200, which has the inner protrusion 220 famed therein. Furthermore, the outer diameter of the portion having the outer protrusion 330 formed therein is larger than the inner diameter of the portion having the inner protrusion 220 formed therein. It should be understood that the outer diameter of the portion having the outer protrusion 330 should be smaller than the inner diameter of the other portion of the second hollow 210 of the housing 200.

The fixing ring 400 is tightly fitted into the second hollow 210 of the housing 200 so that the outer protrusion 330 is located between the inner protrusion 220 and the fixing ring 400. Namely, in a state in which the buffer tube 300 is passed through the housing 200 in such a manner that the outer protrusion 330 and the inner protrusion 220 come in contact with each other and are supported by each other, the fixing ring 400 is tightly fitted into the second hollow 210 of the housing 200, whereby the outer protrusion 330 is located between the inner protrusion 220 and the fixing ring 400. Herein, since the fixing ring 400 has a shape corresponding to the inner diameter of the second hollow 210 of the housing 200, the fixing ring 400 is tightly fitted into the second hollow 210 of the housing 200, and thus tight fitting between the housing 200 and the buffer tube 300 can be achieved. Thus, when the upper end of the buffer tube 300 is pressed down so that the buffer tube 300 and the housing 200 will move together with respect to the chamber 100, the sealing membrane 320 can be broken so that the solution 312 can be discharged.

Meanwhile, the inner protrusion 220 preferably has a plurality of vent holes 222 which extend in a direction in which the second hollow 210 extends. The vent holes are arranged in a circumferential direction so as to be spaced apart from each other. The fixing ring 400 is configured such that at least a portion thereof is smaller than the inner diameter of the second hollow 210 so as to be spaced at a predetermined distance from the inner circumferential surface of the second hollow 210 so as to provide a gap, so that air in the housing 200 may be discharged to an outside through the vent holes 222 and the gap.

The inner protrusion 220 has vent holes 222 extending in a direction in which the second hollow 210 extends. Accordingly, as shown in the drawings, the inner protrusion 220 has vertically extending holes. The vent holes 222 may be provided in a plurality number and may be spaced apart from each other in a circumferential direction.

The fixing ring 400 has a shape and an outer diameter, which approximately correspond to the inner shape of the second hollow 210, and it is configured such that at least a portion thereof is spaced at a predetermined distance from the inner circumferential surface of the second hollow 210 to form a gap. Accordingly, for example, the housing 200 may have a cylindrical shape, and thus the second hollow 210 may also have a cylindrical shape. Furthermore, the fixing ring 400 may have a circular shape, and at least a portion of the outer side surface of the fixing ring 400 may have a recess 420 that is recessed inward. Thus, the outer side surface of the fixing ring 400 comes in contact with the inner circumferential surface of the second hollow 210, so that the fixing ring 400 may be tightly fitted into the second hollow 210 of the housing 200, provided that at least a portion of the fixing ring 400 is spaced at a predetermined distance from the inner circumferential surface of the second hollow 210 to form a gap. For example, as shown in FIG. 5, the outer diameter m of the fixing ring 400 may be similar to the inner diameter l of the second hollow 210 of the housing 200, provided that the outer diameter n of a portion of the fixing ring 400 is smaller than the inner diameter l of the second hollow 210 of the housing 200.

Preferably, the gap between the fixing ring 400 and the inner circumferential surface of the second hollow 210 may overlap the vent holes 222 formed in the inner protrusion 220. Namely, the fixing ring 400 is fixed in position such that the recesses 420 formed in the fixing ring 400 are located at positions corresponding to the positions of the vent holes 222, whereby the vent holes 222 overlap the gap so that the internal space of the housing 200 may be connected to an outside so as to achieve gas exchange.

Due to this configuration, when the fixing ring 400 is fitted into the second hollow 210 of the housing 200, the gap between the second hollow 210 and the fixing ring 400 may overlap the vent holes 222 of the inner protrusion 220 to form air vent regions V. Accordingly, air in the housing 200 and the chamber 100 may be easily discharged to an outside through the air vent regions V. Namely, when the housing 200 and the buffer tube 300 are pressed down and moved downward into the chamber 100, if air therein cannot be discharged to an outside, an excessive force will be required for the downward movement, or the downward movement will be difficult.

However, according to the present disclosure, the air vent regions V are provided as described above, and thus air in the housing 200 may be easily discharged to an outside so that the housing 200 and the buffer tube 300 may be easily moved downward. Furthermore, after the housing 200 and the buffer tube 300 are moved downward, when the solution 312 in the buffer tube 300 is discharged and the solution 312 and the sample solution are discharged through the sampling portion 120, air in the housing 200 is discharged through the air vent regions V so that the solutions can be easily discharged.

According to the present disclosure, sampling, mixing of the sample with the solution 312, and sample dispensing, may be performed in an accurate and convenient manner. For example, for lateral flow immunoassay, a predetermined amount of a sample (such as blood) to be analyzed may be reacted with the solution 312 containing a fluorescent substance-labeled detection antibody and an erythrocyte-lysing reagent, and then a predetermined amount (usually 50 to 150 μL) of the resulting sample solution may be dispensed into the cartridge 4 (in which an antibody specific for the substance to be detected is immobilized on a NC membrane), and lateral flow immunoassay can be performed in a reproducible and accurate manner.

According to the present disclosure, a sample (for example, a biological sample) is simply collected through the sampling portion 120 of the chamber 100 by surface tension, and a predetermined amount of the solution 312 is fed through the buffer tube 300. Thus, collection of the sample and mixing of the sample with a predetermined amount of the solution 312 may be performed in a simple manner, and a predetermined amount of the mixture of the sample and the solution 312 may be accurately loaded through the sampling portion 120. Thus, overall analysis may be performed in a very simple and accurate manner without a complicated operation.

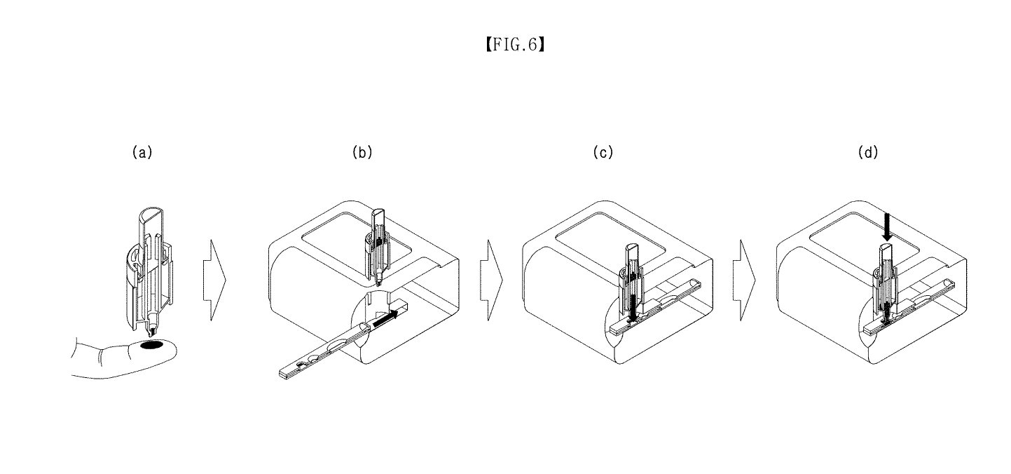

FIG. 6 shows the sequential steps of an analysis process using a sample dispensing device 1 according to an embodiment of the present disclosure.

As shown in FIG. 6(A), a sample is collected, and in this state, as shown in FIG. 6(B), the user inserts the sample dispensing device 1 into a reader. As shown in FIG. 6(C), when the sample dispensing device 1 is pressed down, the extruding protrusion 6 then perforates the sealing membrane 4, and as shown in FIG. 6(D), a detection solution 3 moves into the chamber 100 having the sampling portion 120 provided therein. Herein, in the initial stage, the surface tension of the sample is greater than the gravity of the solution 312, and thus the solution does not flow down. When the amount of the solution 312 increases to increase the gravity thereof, the mixture solution of the sample and the solution 312 flows down through the sampling portion 120 until the surface tension is equal to the gravity. Herein, the presence of air in the chamber interferes with the flowing down of the mixture solution. For this reason, the air vent regions V consisting the vent holes 222 and the gap of the fixing ring 400 are provided, and the mixture of the sample and the solution 312 can easily flow down. The solution that flows down is loaded into the sample inlet of the cartridge 4.

In another aspect, the present disclosure is directed to a method for analyzing a biological sample using the device according to the present disclosure, the method comprising the steps of: providing the biological sample; bringing the sampling portion of the device into contact with the biological sample to introduce or flow in the biological sample into the sampling portion; and operating the device to perforate the sealing membrane by the extending protrusion to thereby move the solution into the space of the housing and the chamber and mix the solution with the biological sample, wherein the mixture of the solution and the biological sample is discharged to an outside through the sampling portion.

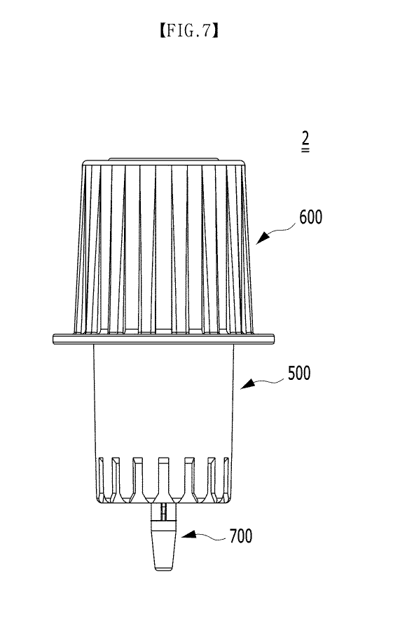

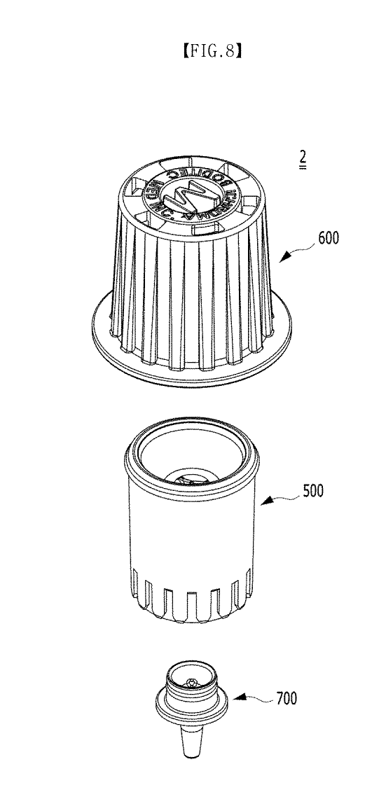

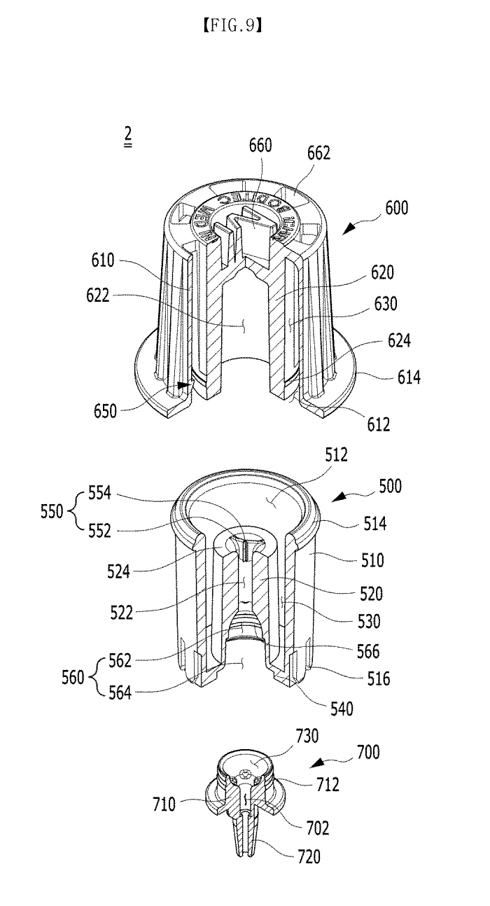

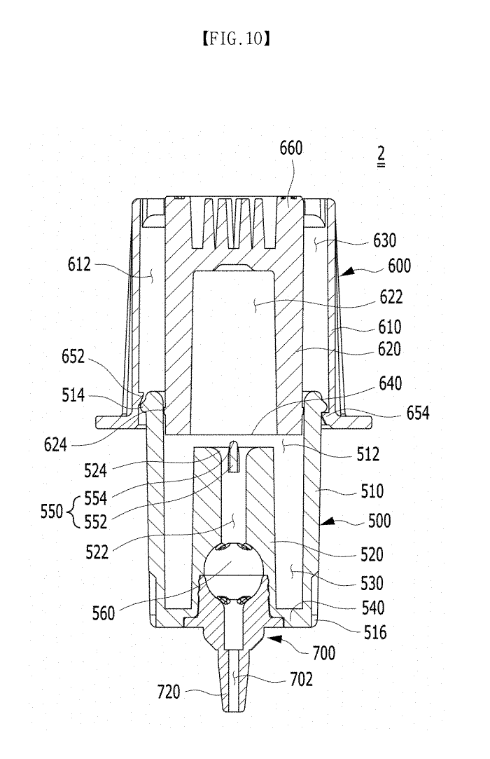

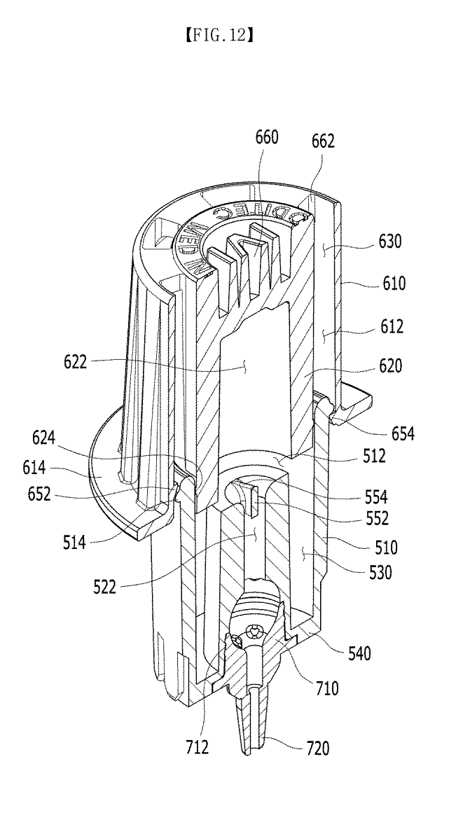

FIGS. 7 to 12 show a sample dispensing device 2 according to another embodiment of the present disclosure. Specifically, FIGS. 7 to 12 show the appearance, exploded view, cross-sectional view and partial cross-sectional view of the sample dispensing device 2, respectively.

Referring to FIGS. 7 to 12, the sample dispensing device 2 according to the embodiment of the present disclosure comprises: a chamber portion 500 having a vertically extending dual-tube structure; an upper cap 600 having a vertically extending dual-tube structure and disposed above the chamber portion 500, the upper cap 600 being configured to be filled with a specific solution; and a sampling portion 700 disposed at the bottom of the chamber portion 500 and having a tubular channel 702 through which a specific sample may be collected or the solution may be discharged.

First, the chamber portion 500 will now be described.

The chamber portion 500 comprises an outer circumferential portion 510, a line potion 520, an inner groove 530, a lower-end connecting portion 540, and a recess 560.

The outer circumferential portion 510 has a cylindrical shape, constitutes the outer circumference of the chamber portion 500, and has a first hollow 512 which is open at its upper end and which has a predetermined inner diameter.

On the upper end edge of the outer circumferential portion 510, a first locking protrusion portion 514 is provided which protrudes outward so as to have a certain width. The first locking protrusion portion 514 is composed of a circular protrusion portion extending along the upper outer circumference of the outer circumferential portion 510.

Meanwhile, on the lower end edge of the outer circumferential portion 510, a plurality of connection grooves 516 may be formed which may be connected to a certain external device. The connection grooves 516 may be connected with connection protrusions 912 formed on the chamber insertion holder 910 of a sample adapter 3 as described below.

The line portion 520 is disposed in the first hollow 512. Specifically, the line portion 520 is disposed in the first hollow 512 so as to be spaced at a predetermined distance from the outer circumferential portion 510 in the diameter direction, and extends in the lengthwise direction of the outer circumferential portion 510. Thus, the chamber portion 500 has a dual-tube structure defined by the outer circumferential portion 510 and the line portion 520. Preferably, the height of the line portion 520 is smaller than the height of the outer circumferential portion 510.

In the line portion 520, a vertically extending discharge line 522 is formed. The discharge line 522 may be composed of a specific channel, and thus as described below, a specific solution may be discharged downward through the discharge line 522.

At the upper end of the discharge line 522, an enlarged portion 524 may be formed which has a funnel shape whose inner diameter increases upward.

In addition, at the upper end of the line portion 520, a ripping portion 550 configured to rip a sealing cover 640 as described below may be provided. The ripping portion 550 may comprise: at least one transverse beam 552 provided at the upper end of the discharge line 522 so as to traverse the discharge line 522 in the diameter direction; and an upwardly protruding blade portion 554 disposed at the upper end of the transverse beam 552. Namely, the ripping portion 550 protrudes upward so that it may come into contact with the sealing cover 640 as described below so as to easily rip the sealing cover 640.

The inner groove 530 is a space defined between the outer circumferential portion 510 and the line portion 520. Namely, the inner groove 530 is a cylindrical space having a specific width and depth, formed between the outer circumferential portion 510 and the line portion 520, which are spaced at a predetermined distance from each other. The inner groove 530 forms a portion of the first hollow 512.

The lower-end connecting portion 540 serves to connect the lower end of the outer circumferential portion 510 with the lower end of the line portion 520. Accordingly, the lower-end connecting portion 540 may generally have a ring shape and may form the bottom of the inner groove 530. The height in the description “the height of the line portion 520 is smaller than the height of the outer circumferential portion 510” may refer to the height from the lower-end connecting portion 540.

The recess 560 is composed of a recessed space famed by the lower portion of the line portion 520, which is recessed upward so as to have a specific depth and volume.

The recess 560 comprises a first hemispherical dome 562 formed at an upper portion and an inwardly recessed region 564 formed at a lower portion.

The first hemispherical dome 562 has a hemispherical shape and is composed of a specific hemispherical space recessed upward. As used herein, the “hemispherical shape” is not necessarily limited to an exactly hemispherical shape, and may also be any three-dimensional shape.

The inwardly recessed region 564 is located beneath the first hemispherical dome 562, and has a cylindrical shape having an inner diameter greater than the diameter of the first hemispherical dome 562. Meanwhile, on the inner circumferential surface of the inwardly recessed region 564, a female screw portion 566 may be formed.

Hereinafter, the upper cap 600 will be described.

The upper cap 600 may comprise a cap portion 610, a tube portion 620, an outer groove 630, a cap cover 660, and a sealing cover 640.

The cap portion 610 constitutes the outer circumference of the upper cap 600, and has a second hollow 612 which is open at its lower end and which has a predetermined inner diameter. On the outer circumferential surface of the cap portion 610, a gripping portion having irregularities may be formed so as to facilitate the user's gripping. In addition, around the outer circumferential surface of the lower end of the cap portion 610, a side plate portion 614 may be provided which protrudes outward.

On the inner circumferential surface of the cap portion 610, a second locking protrusion portion 650 is provided which protrudes inward so as to have a specific width. The second locking protrusion portion 650 may comprise a plurality of upper protrusions 652 and a plurality of lower protrusions 654.

The upper protrusions 652 protrude from the inner circumferential surface of the cap portion 610 so as to have a specific width, extend in a circumferential direction so as to have a specific length, and are spaced apart at a predetermined distance from each other. In addition, the lower protrusions 654 are disposed below the upper protrusions 652 so as to be spaced at a predetermined distance in the vertical direction, protrude from the inner circumferential surface of the cap portion 610 so as to have a specific width, extend in a circumferential direction so as to have a specific length, and are spaced apart at a predetermined distance from each other.

Preferably, the upper protrusions 652 and the lower protrusions 654 are alternately disposed around the inner circumferential surface of the cap portion 610. Namely, the upper protrusions 652 and the lower protrusions 654 may be alternately disposed in the circumferential direction.

The tube portion 620 is disposed in the second hollow 612 of the cap portion 610. Specifically, the tube portion 620 is disposed in the second hollow 612 so as to be spaced at a predetermined distance from the cap portion 610 in the diameter direction, and extends in the lengthwise direction of the cap portion 610. Thus, the upper cap 600 has a dual-tube structure defined by the cap portion 610 and the tube portion 620.

In the tube portion 620, a solution or buffer filling space 622 is formed which has a specific volume and which is open at its lower end. In the solution filling space 622, a specific liquid solution (e.g., buffer) required for reaction may be filled.

Meanwhile, around the outer circumference of the lower end of the tube portion 620, a frictional protrusion 624 may be provided which protrudes outward so as to have a specific width and which extends in the circumferential direction.

The outer groove 630 is a space defined between the cap portion 610 and the tube portion 620. Namely, the outer groove 630 is a cylindrical space having a specific width and depth, formed by the cap portion 610 and the tube portion 620, which are spaced at a predetermined distance from each other in the diameter direction. The outer groove 630 forms a portion of the second hollow 612. The cap cover 660 connects the upper end of the cap portion 610 with the upper end of the tube portion 620 and closes the upper end of the tube portion 620. Accordingly, the cap cover 660 generally has a circular plate shape. Preferably, in the edge portion of the cap cover 660, through-holes 662 that extend vertically may be formed. The through-holes 662 may communicate with the outer groove 630.

The sealing cover 640 is an element such as a thin membrane, which is provided at the lower end of the tube portion 620. The sealing cover 640 may be made of a specific waterproof material so as to seal the lower end of the solution filling space 622 and to prevent the solution in the solution filling space 622 from flowing out. Thus, the solution filling space 622 may be sealed by the upper cap cover 660 and the lower sealing cover 640 in a state in which a solution is filled therein. The sealing cover 640 seals the filling space 622 to prevent the solution in the filling space 622 from unnecessarily flowing out. Preferably, after a solution is filled in the filling space 622, the sealing cover 640 is disposed at the lower end by a process such as attachment, bonding or the like, so that the solution in the filling space 622 may be maintained in a filled state. Meanwhile, the sealing cover 640 has a relatively thin thickness so that it can be broken by the ripping portion 550 disposed on the line portion 520 as described below. For example, the sealing cover 640 may be made of a thin aluminum film, a thin vinyl film or the like, but is not limited thereto.

Hereinafter, the sampling portion 700 will be described.

The sampling portion 700 may comprise a tubular channel 702, an inner fitting portion 710, a sampling tip 720, and a second hemispherical dome 730.

The tubular channel 702 is composed of a tube which extends in the vertical direction of the sampling portion 700 and which has a specific inner diameter. The inner diameter of the tubular channel 702 may generally be uniform, or as shown in the drawings, may be narrower in the lower portion than in the upper portion. As described below, the sampling tip 720 in the tubular channel 702 has a capillary shape, and thus can collect a sample by a capillary phenomenon.

The inner fitting portion 710 is a specific cylindrical element located in the upper portion of the sampling portion 700. Preferably, the inner fitting portion 710 has an outer diameter corresponding to the inner diameter of the inwardly recessed region 564 so as to be fitted into the inwardly recessed region 564. On the outer circumferential surface of the inner fitting portion 710, a male screw portion 712 may be formed which is engaged with the female screw portion 566 formed on the inwardly recessed region 564. As described above, the sampling tip 720 is located in the upper portion of the sampling portion 700 and has a capillary tube formed therein so that it can collect a sample, in which the capillary tube communicates with the tubular channel 702. The sampling tip 720 enables a liquid sample (such as blood) to flow into the tubular channel 702 (i.e., capillary tube) of the sampling tip 720 by surface tension or the like, and has a slender tube shape, but the shape thereof is not specifically limited.

The amount of liquid sample collected may be adjusted by adjusting the volume of the tubular channel (for example, capillary tube) of the sampling tip 720. The volume of the capillary tube may be adjusted by the diameter and/or length thereof with a range that does not impair the capillary phenomenon.

The second hemispherical dome 730 is defined by the inner fitting portion 710 and is composed of a downwardly recessed hemispherical space. As used herein, the “hemispherical shape” is not necessarily limited to an exactly hemispherical shape, and may also be any three-dimensional shape.

In an embodiment of the present disclosure, the sampling portion 700 may be detachably attached to the chamber portion 500, and may advantageously be used to collect various amounts of a sample depending on the kind of substance to be detected and/or sample. Namely, the amount of sample required may vary depending on the kind of substance to be detected, the kind of biological sample, or the sensitivity of analysis method used. Thus, depending on the amount of sample required for analysis, various kinds of sampling portions 700 comprising various kinds of sampling tips having capillary tubes formed therein as described above may be manufactured, and a suitable sampling portion selected depending on the kind of substance to be detected and/or the kind of biological sample and/or the kind of analysis method may be used.

Hereinafter, the connection between the chamber portion 500, the upper cap 600 and the sampling portion 700 will be described.

First, the coupling structure between the upper cap 600 and the chamber portion 500 will be described.

The upper cap 600 is disposed over the chamber portion 500, and the lower end of the upper cap 600 is connected to the upper end of the chamber portion 500 so that the upper cap 600 is vertically movable with respect to the chamber portion 500.

More specifically, the lower end of the upper cap 600 is connected to the upper end of the chamber portion 500 in such a manner that the outer circumferential portion 510 of the chamber portion 500 is inserted into the outer groove 630 of the upper cap 600 and inserted between the cap portion 610 and the tube portion 620.

At this time, the first locking protrusion portion 514 is interlocked with the second locking protrusion portion 650, and the upper end of the outer circumferential portion 510 is tightly fitted between the cap portion 610 and the tube portion 620. Thus, the lower end of the cap portion 610 and the upper end of the chamber portion 500 are connected to each other and fixed in position.

Specifically speaking, when the lower end of the upper cap 600 is connected with the upper end of the chamber portion 500, the upper protrusions 652 formed on the inner circumferential surface of the lower end of the cap portion 610 are then located on the first locking protrusion portions 514 formed on the outer circumferential surface of the upper end of the chamber portion 500, and the lower protrusions 654 are located beneath the first locking protrusion portion 514. Thus, the first locking protrusion portion 514 is fitted between the upper protrusions 652 and the lower protrusions 654, and thus the cap portion 610 and the chamber portion 500 are fixed in position. Namely, in the absence of an external force, the coupling structure as described above is maintained.

At this time, the line portion 520 is located beneath the tube portion 620. More specifically, the line portion 520 is located immediately beneath the solution filling space 622 of the tube portion 620.

As described above, the height of the line portion 520 is smaller than the height of the outer circumferential portion 510. Thus, when the upper end of the chamber portion 500 is tightly connected with the lower end of the upper cap 600, the sealing cover 640 and the line portion 520 are in a state in which they are spaced apart from each other in the vertical direction, and the solution in the solution filling portion is maintained in a state in which it is filled in the solution filling space 622.

Now, the coupling structure between the sampling portion 700 and the chamber portion 500 will be described.

The sampling portion 700 is connected to the lower end of the chamber portion 500. Specifically, the inner fitting portion 710 in the upper portion of the sampling portion 700 is fitted into the inwardly recessed region 564 formed in the lower portion of the line portion 520 of the chamber portion 500. As described above, the inner fitting portion 710 and the inwardly recessed region 564 have the male screw portion 712 and the female screw portion 566, respectively, and thus may be screw-coupled to each other.

When the sampling portion 700 and the chamber portion 500 are coupled to each other as described above, the first hemispherical dome 562 together with the second hemispherical dome 730 forms a spherical space. As described above, the “spherical space” does not necessarily mean a completely spherical shape. Furthermore, the discharge line 522 formed in the line portion 520 of the chamber portion 500 is connected to the tubular channel 702 of the sampling portion 700 to form a single discharge channel.

Hereinafter, the operation and use of the sample dispensing device 2 according to this embodiment will be described.

As described above, when an external force is applied to upper cap 600 connected to the chamber portion 500, the upper cap 600 may move downward. Specifically, when a downward force is applied to the upper cap 600, it overcomes the interlocking force between the first locking protrusion portion 514 and the second locking protrusion portion 650, and the upper cap 600 then moves downward.

While the upper cap 600 moves downward, the outer circumferential portion 510 is inserted into the outer groove 630. At this time, as described above, through-holes may preferably be formed in the cap cover 660, and thus air in the outer groove 630 may be easily discharged.

While the upper cap 600 moves downward, the tube portion 620 comes into close contact with the line portion 520, and when the upper cap 600 further moves downward, the ripping portion 550 provided at the top of the line portion 520 then rips the sealing cover 640. Thus, the solution filled in the solution filling space 622 is discharged downward. The solution is discharged downward through the discharge line 522 of the line portion 520 and the tubular channel 702 of the sampling portion 700.

Preferably, the outer diameter and cross-sectional shape of the line portion 520 may correspond to the inner diameter and cross-sectional shape of the solution filling space 622. Namely, for example, when the line portion 520 is composed of a cylindrical body having a specific outer diameter, the solution filling space 622 may also be composed of a cylindrical space having the same inner diameter as the outer diameter of the solution filling space. Thus, when the upper cap 600 moves downward, the line portion 520 perforates the sealing cover 640, and is then air-tightly inserted into the solution filling space 622, and the solution in the solution filling space 622 moves along the discharge line 522 without being discharged to an outside, and is discharged through the sampling portion 700. In this process, the solution is mixed and discharged with a sample (such as blood) collected by a slender tube which can induce a capillary phenomenon by surface tension in the sampling tip 720.

In this embodiment, sample testing or analysis may be performed using a very simplified structure and a small number of parts. Namely, because the tube portion 620 which is filled with a solution is integrated with the upper cap 600 disposed above the chamber portion 500, the number of parts can be reduced. Furthermore, because the upper cap 600 is selectively separated from and connected to the chamber portion 500, a solution to be used for analysis can be simply selected. Moreover, because the solution can be discharged by simply pressing down the upper cap 600, analysis can be conveniently performed. In addition, because the sampling portion 700 is detachable and various sampling portions 700 having various volumes of sampling tips 720 are manufactured in order to satisfy the amount of sample required for sample testing or analysis, a suitable sampling portion can be suitably selected depending on a desired volume to thereby maximize convenience.

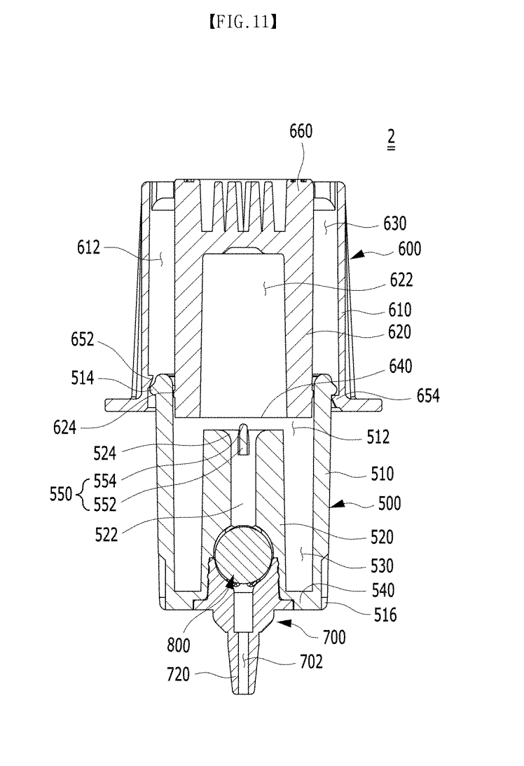

Meanwhile, FIG. 11 shows the device of this embodiment, which further comprises a dry reagent 800.

The dry reagent 800 is a reagent obtained by drying a specific reagent required for the reaction of, for example, a biological sample with a specific detection antibody. This dry reagent 800 may be disposed in the spherical space formed by the first hemispherical dome 562 together with the second hemispherical dome 730 as described above. For example, when the sampling portion 700 is coupled to the chamber portion 500 in a state in which the second hemispherical dome 730 contains the dry reagent 800, the dry reagent 800 may be located in the spherical space.

As the dry reagent 800 is located in the spherical space as described above, the dry reagent 800 can be dissolved when the solution in the solution filling portion moves along the discharge line. The mixture of the dissolved dry reagent 800 and the solution may be mixed with the sample of the sampling tip 720 and discharged to an outside. Thus, various solutions may be mixed with a sample by a simple and convenient operation and used for analysis.

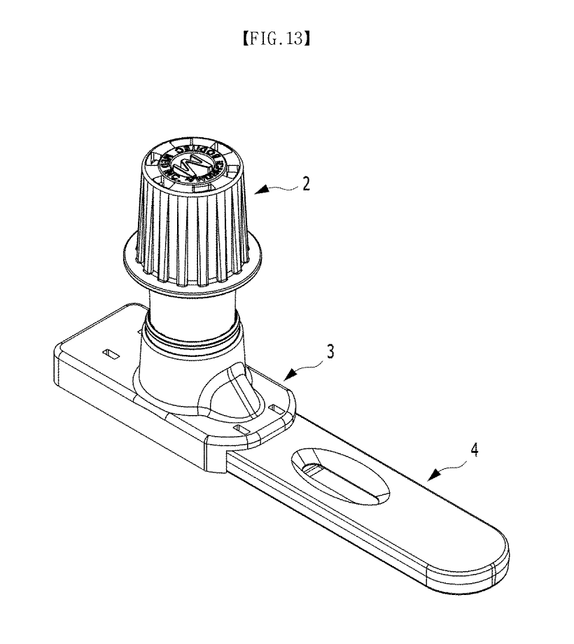

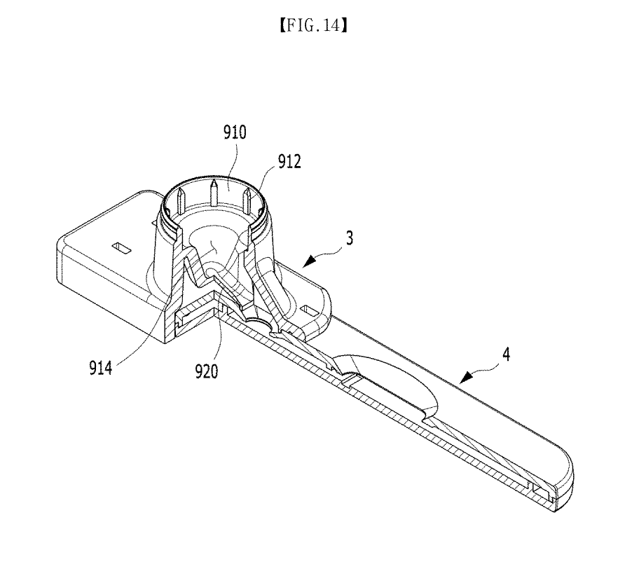

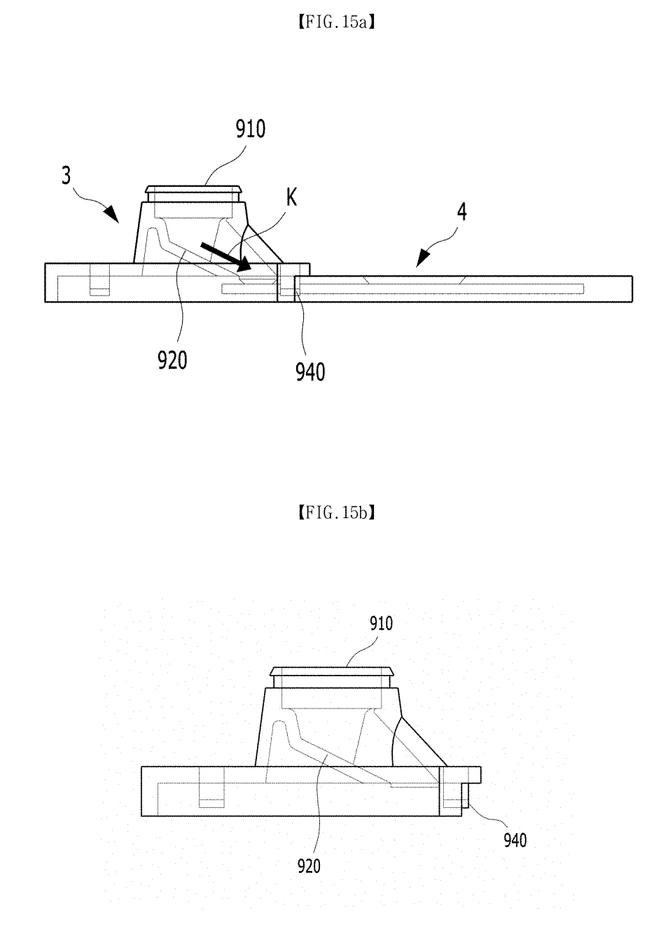

FIG. 13 shows a sample analysis device according to a second embodiment of the present disclosure, which comprises a sample dispensing device 2 connected to an adapter 3, and a cartridge 4; FIG. 14 shows the internal structures of a sample adapter 3 and a cartridge inserted therein; and FIG. 15 shows the cross-sections of an adapter and a cartridge 4 inserted therein.

The sample dispensing device 2 according to the present disclosure may be used together with the adapter 3.

In one embodiment, the sample dispensing device 2 according to the present disclosure may be manufactured separately from the adapter 3.

In another embodiment, the sample dispensing device 2 according to the present disclosure may be manufactured integrally with the adapter 3.

The adapter 3 comprises: an insertion holder 910 configured such that the sample dispensing device 2 is inserted and fixed in position; an inclined line 920; and a cartridge inserting portion 940.

The insertion holder 910 is composed of a cylindrical portion having a specific space so that the lower end of the chamber portion 500 of the sample dispensing device 2 may be tightly inserted therein. On the inner circumferential surface of the insertion holder 910, a plurality of connection protrusions 912 may be provided which may be coupled with the connection grooves 516 formed at the lower end of the outer circumferential portion 510 of the chamber 500. Thus, the sample dispensing device 2 may be inserted into the insertion holder 910 and fixed in position.

The inclined line 920 is provided at a bottom in the insertion holder 910. The inclined line 920 extends in one direction and has a slope inclined at a certain angle. Thus, a sample and a solution, discharged from the sample dispensing device 2, are mixed along the slope, guided in one direction, and loaded into the cartridge 4.

As shown in FIG. 15, a solution and a sample, discharged from the sample dispensing device 2, move along the inclined line 920 as indicated by the arrow K, and are loaded onto the sample pad of the cartridge 4 located at the side.

The adapter 3 makes it easy to load a sample from the cartridge connected thereto onto the sample pad, and further makes it easy to load the sample into the sample pad, because it has formed therein a space to retain a certain volume of the mixture discharged from the sample dispensing device. For example, a sample (such as blood) is collected by the sampling portion 700, after which the sample dispensing device is mounted in the adapter 3. When the upper cap 600 is pressed down, the sealing cover 640 is then ripped by the ripping portion 550, and the buffer solution filled in the tube portion 620 is discharged, moves along the discharge line 522, passes through the space defined by the first hemispherical dome of the recess 560 formed at the lower end of the discharge line and the second hemispherical dome, and then passes through sampling portion 700 while being mixed with a sample (such as blood) in the sampling portion and discharged. Where the defined space contains a dry reagent, the dry reagent is also dissolved during the discharge process and discharged. In order to facilitate mixing of a buffer solution and a biological sample (such as blood), optionally a dry reagent, the adapter has an inclined line 920. The mixture is further mixed while it moves along the inclined line 920, and then it is loaded onto the sample pad of the cartridge in a well mixed state, whereby more reproducible results can be obtained.

In such terms, the sample dispensing device 2 is connected to the adapter 3 in such a manner that the end of the sampling portion 700 is located along the slope of the inclined line included in the adapter 3. Particularly, the end of the sampling portion 700 is preferably located on the inclined line so as to be a long distance from the sample pad.

Hereinafter, the sequential steps of an analysis process using the sample dispensing device 2 according to one embodiment of the present disclosure will be described. Generally, as shown in FIG. 6(A), a sample is collected using the sampling tip, and then if necessary, the sample dispensing device is connected to the adapter 3 which is then connected to the cartridge 4. However, the sequence of connection is not limited thereto, and the cartridge may first be inserted, and then the sample dispensing device may be connected thereto.

As shown in FIG. 6(A), a sample is collected using the sample dispensing device 2, and in this state, the sample dispensing device 2 is inserted into the adapter, if necessary. When the upper cap is pressed down, the sealing cover 640 is then perforated by the ripping portion 550, and the solution in the solution filling space 622 moves along the discharge line 522 to the chamber 500 having the sampling portion 700 provided therein. In the initial stage of this process, the sample does not flow down due to its surface tension, and as the solution flows down due its gravity, the sample of the sampling tip is mixed with the solution and flows down. Because the extending protrusion 130 of the sample dispensing device 1 has a continuous circular shape, it is tightly fitted to the upper cap 600 to form pressure, and thus the solution does not flow in the chamber portion 500, but flows only through the discharge line 522. Furthermore, the sampling portion 700 is detachable, and when sampling tips are manufactured to have various volumes, a sampling portion 700 having a suitable volume may be selected and used depending on the kind of substance to be analyzed or detected, the kind of reaction and/or the kind of sample. In addition, if an additional reagent is required in addition that contained in the solution, it may be dried and disposed in the space defined by the first hemispherical dome and the second hemispherical dome. The dry sample is mixed with the discharged solution, and ultimately, mixed with the sample of the sampling tip.

In such terms, the present disclosure is directed to a method for analyzing a biological sample using the sample dispensing device of the present disclosure, the method comprising the steps of: providing a biological sample such as blood; bringing the sampling tip of the sampling portion of the device into contact with the biological sample, and introducing the biological sample into the sampling tip by the contact; and applying an external force to the cap portion to move the upper cap downward, wherein the sealing cover is perforated by the ripping portion, whereby a solution contained in the solution filling space of the cap portion moves along the discharge line of the chamber portion, and the biological sample and the solution are mixed with each other and discharged to an outside. The method according to the present disclosure may further comprise, after the step of introducing the biological sample into the sampling tip, a step of mounting the device in an adapter, wherein the device is connected to the adapter through the lower end of the chamber portion, and the adapter is inserted into a cartridge including an analysis device such as a lateral flow analysis device, and the discharged mixture is loaded into a specific portion of the cartridge.

The method according to the present disclosure is performed in vitro, and may be conveniently used to determine the presence and absence and amount of a certain component required to provide information which is required to detect or diagnose a disease in biological samples (e.g., blood including whole blood, plasma, serum, etc., saliva, urine, etc.) derived from mammals, for example, humans.

Although the preferred embodiments of the present disclosure have been described for illustrative purposes, those skilled in the art will appreciate that various modifications are possible, without departing from the scope and spirit of the disclosure as disclosed in the accompanying claims, and it should not be understood that such modifications are different from the technical idea of the present disclosure.

1-10. (canceled)

11. A sample dispensing device comprising:
a chamber portion having a vertically extending dual-tube structure;
an upper cap having a vertically extending dual-tube structure and disposed above the chamber portion, the upper cap being configured to be filled with a predetermined solution; and
a sampling portion disposed at the bottom of the chamber portion and having a tubular channel through which a predetermined sample is collected or the solution is discharged,
wherein the chamber portion comprises: a cylindrical outer circumferential portion which constitutes an outer circumference and which has a first hollow open at its upper end and having a predetermined inner diameter; a cylindrical line portion disposed in the first hollow so as to be spaced at a predetermined distance from the outer circumferential portion in a diameter direction, the cylindrical line portion extending in a lengthwise direction of outer circumferential portion and having a vertically extending discharge line; an inner groove defined by a space between the outer circumferential portion and the line portion; and a lower-end connecting portion which connects the lower end of the outer circumferential portion with the lower end of the line portion;
the upper cap comprises: a cap portion which constitutes the outer circumference and has a second hollow at open at its lower end and having a predetermined inner diameter; a tube portion disposed in the second hollow so as to be spaced at a predetermined distance from the cap portion in a diameter direction, the tube portion extending in the lengthwise direction of the cap portion and having a solution filling space open at its lower end; an outer groove defined by a space between the cap portion and the tube portion; a cap cover which connects the upper end of the cap portion with the upper end of the tube portion and closes the upper end of the tube portion; and a sealing cover provided at the lower end of the tube portion so as to seal the lower end of the solution filling space and made of a thin membrane,
wherein the upper cap is connected to the chamber portion so as to be vertically movable with respect to the chamber portion, in such a manner that the line portion is located below the tube portion, and the upper cap is configured such that when the upper cap moves downward, the sealing cover is perforated by the line portion and the solution passes through the discharge line and is discharged to an outside through the tubular channel of the sampling portion.

12. The sample dispensing device of claim 11, wherein the lower end of the upper cap is connected to the upper end of the chamber portion in such a manner that the outer circumferential portion of the chamber portion is inserted into a lower end of the outer groove of the upper cap and inserted between the cap portion and the tube portion, and the cap portion is configured such that when the upper cap moves downward by an external force, the outer circumferential portion is inserted into the outer groove and the line portion is inserted into the solution filling space of the tube portion.

13. The sample dispensing device of claim 11, wherein the outer surface of the upper end of the outer circumferential portion has a first locking protrusion portion which protrudes outward in the diameter direction so as to have a predetermined width, and the inner surface of the lower end of the cap portion has a second locking protrusion portion which protrudes inward in the diameter direction so as to have a predetermined width, and thus when the lower end of the upper cap portion is coupled to the upper end of the chamber portion, the first locking protrusion portion and the second locking protrusion portion are interlocked with each other so that the upper end of the outer circumferential portion is tightly fitted between the cap portion and the tube portion, whereby the lower end of the cap portion and the upper end of the chamber portion are connected to each other and fixed in position.

14. The sample dispensing device of claim 13, wherein
the first locking protrusion portion is composed of a circular protrusion portion extending along the upper outer circumference of the outer circumferential portion;
the second locking protrusion portion comprises: a plurality of upper protrusions which protrude from the inner circumferential surface of the cap portion so as to have a predetermined width, extend in a circumferential direction so as to have a predetermined length, and are spaced apart at a predetermined distance from each other; and a plurality of lower protrusions which are disposed below the upper protrusions so as to be spaced at a predetermined distance in the vertical direction, protrude from the inner circumferential surface of the cap portion so as to have a predetermined width, extend in a circumferential direction so as to have a predetermined length, and are spaced apart at a predetermined distance from each other; and
when the lower end of the upper cap portion is coupled to the upper end of the chamber portion, the upper protrusions are located over the first locking protrusion portion, and the lower protrusions are located beneath the first locking protrusion portion, whereby the cap portion and the chamber portion are fixed in position.

15. The sample dispensing device of claim 14, wherein the upper protrusions and the lower protrusions are alternately disposed along an inner circumferential surface of the cap portion.

16. The sample dispensing device of claim 11, wherein the outer circumference of the lower end of the tube portion has a frictional protrusion which protrudes outward so as to have a predetermined width and which extends in the circumferential direction to come into close contact with the inner circumferential surface of the upper end of the outer circumferential portion.

17. The sample dispensing device of claim 11, wherein the height of the line portion is smaller than the height of the outer circumferential portion, and thus when the upper end of the outer circumferential portion is tightly connected with the lower end of the cap portion, the sealing cover and the line portion are spaced apart from each other in a vertically direction, and when the upper cap moves downward by a predetermined distance, the line portion perforates the sealing cover so that the solution in the solution filling space is discharged through the discharge line.

18. The sample dispensing device of claim 11, wherein the outer diameter and cross-sectional shape of the line portion correspond to the inner diameter and cross-sectional shape of the solution filling space, and thus when the upper cap moves downward, the line portion perforates the sealing cover and is inserted into the solution filling space, and the solution in the solution filling space is discharged through the discharge line without being discharged to an outside.

19. The sample dispensing device of claim 11, wherein the upper end of the discharge line has an enlarged portion which has a funnel shape whose inner diameter increases upward.

20. The sample dispensing device of claim 11, wherein the upper end of the line portion has a ripping portion configured to rip the sealing cover, in which the ripping portion comprises: at least one transverse beam provided at the upper end of the discharge line so as to traverse the discharge line in the diameter direction; and an upwardly protruding blade portion disposed at the upper end of the transverse beam.

21. The sample dispensing device of claim 11, wherein the chamber portion further comprises a recess formed by the lower portion of the line portion, which is recessed upward,
in which the recess has a first hemispherical dome, which is located at an upper portion and has a hemispherical shape and recessed upward, and an inwardly recessed region which is located beneath the first hemispherical dome and has a cylindrical shape having an inner diameter greater than the diameter of the first hemispherical dome, and
the sampling portion has an inner fitting portion which is located in an upper portion of the sampling portion and has a cylindrical shape and an outer diameter corresponding to the inner diameter of the inwardly recessed region so as to be inserted into the inwardly recessed region, a sampling tip which is located in a lower portion of the sampling portion and has a slender tube shape so as to collect a sample, and a second hemispherical dome which is formed on the inner fitting portion and has a hemispherical shape and is recessed downward so as to form a spherical space together with the first hemispherical dome.

22. The sample dispensing device of claim 21, wherein a female screw portion is formed on the inner circumferential surface of the inwardly recessed region, and a male screw portion that is coupled with the female screw portion is formed on the outer circumferential surface of the inner fitting portion.

23. The sample dispensing device of claim 21, further comprising a dry reagent which is disposed in the spherical space formed by the first hemispherical dome together with the second hemispherical dome and is dissolved and mixed with the solution when the solution is discharged.

24. The sample dispensing device of claim 11, further comprising an adapter,
in which the adapter comprises:
a chamber insertion holder having a space therein and configured such that the lower end of the chamber portion is tightly inserted therein;
a slope provided at a bottom in the chamber insertion holder and inclined in one direction and configured to guide the discharged sample and solution in one direction; and
a cartridge insertion portion configured such that a cartridge for use in analysis of the sample is inserted therein.

25. The sample dispensing device of claim 24, wherein the adapter is formed separately from or integrally with the sample dispensing device.

26. A method of analyzing a biological sample using the device of claim 20, the method comprising the steps of:
providing a biological sample;
contacting the sampling tip of the sampling portion of the device with the biological sample, whereby the biological sample is flowed into the sample tip; and
applying an external force to the cap portion to move the upper cap downward, whereby the sealing cover is perforated by the ripping portion, and a solution contained in the solution filling space of the cap portion moves along the discharge line of the chamber portion during which the biological sample and the solution are mixed together and discharged to an outside.

27. The method of claim 26, further comprising a step of mounting the device to an adapter after the biological sample flow-in step, in which the device is coupled to the adapter through the lower end of the chamber portion.
